(19) United States
(12) Patent Application Publication
(10) Pub. No.: US 2024/0414731 A1
(43) Pub. Date: Dec. 12, 2024

(54) TRANSMISSION METHOD, TERMINAL, AND NETWORK-SIDE DEVICE

(71) Applicant: VIVO MOBILE COMMUNICATION CO., LTD., Dongguan (CN)

(72) Inventors: Xiaohang CHEN, Dongguan (CN); Gen LI, Dongguan (CN)

(73) Assignee: VIVO MOBILE COMMUNICATION CO., LTD., Dongguan (CN)

(21) Appl. No.: 18/814,420

(22) Filed: Aug. 23, 2024

Related U.S. Application Data
(63) Continuation of application No. PCT/CN2023/077250, filed on Feb. 20, 2023.

(30) Foreign Application Priority Data
Feb. 24, 2022 (CN) 202210174106.8

(51) Int. Cl. H04W 72/231; H04B 7/06; H04L 1/1812; H04L 5/00; H04W 72/1273

(52) U.S. Cl. CPC H04W 72/231; H04B 7/06968; H04L 1/1812; H04L 5/0051; H04W 72/1273

(57) ABSTRACT

A transmission method, and a terminal are provided. The transmission method includes: obtaining, by a terminal, first indication information. The method further includes performing, by the terminal, a first operation based on the first indication information. The first indication information includes at least one of the following: number of one or more Control Resource Sets (CORESETs), or the quantity of one or more CORESETs, or number of one or more CORESET pools; one or more Transmission Configuration Indicator (TCI) states, or one or more TCI state sets; one or more time windows; number of an enabled or disabled Transmission and Reception Point (TRP), or the quantity of enabled or disabled TRPs; or a mode of an enabled or disabled TRP. The first operation includes at least one of the following: monitoring or not monitoring a Physical Downlink Control Channel (PDCCH); or performing or not performing rate matching.

### CROSS-REFERENCE TO RELATED APPLICATIONS

This application is a continuation of International Application No. PCT/CN2023/077250, filed on Feb. 20, 2023, which claims priority to Chinese Patent Application No. 202210174106.8, filed on Feb. 24, 2022. The entire contents of each of the above-referenced applications are expressly incorporated herein by reference.

### TECHNICAL FIELD

This application pertains to the field of communication technologies, and specifically relates to a transmission method, a terminal, and a network-side device.

### BACKGROUND

The 3rd Generation Partnership Project (3GPP) has put forward a multi Transmission and Reception Point (multi-TRP) or multi-panel scenario. Multi TRP transmission can improve transmission reliability and throughput performance. For example, a terminal can receive same data or different data from multiple TRPs.

When multi-TRP transmission is enabled in a network, the network and the terminal work in multi-TRP mode, which is advantageous for improving throughput and reliability. However, when load of the network is reduced, the network and the terminal still work in multi-TRP mode, resulting in an unnecessary energy loss. In the related art, using Radio Resource Control (RRC) signaling in the network to semi-statically configure the terminal to work in multi-TRP mode can hardly adapt to an energy-saving requirement brought about by a dynamic change of load.

### SUMMARY

Embodiments of this application provide a transmission method, a terminal, and a network-side device.

According to a first aspect, a transmission method is provided and applied to a terminal. The method includes: obtaining, by the terminal, first indication information; and performing, by the terminal, a first operation based on the first indication information, where the first indication information includes at least one of the following: number(s) of one or more Control Resource Sets (CORESETs), or a quantity of one or more CORESETs, or number(s) of one or more CORESET pools; one or more Transmission Configuration Indicator (TCI) states, or one or more TCI state sets; one or more time windows; a number of an enabled or disabled TRP, or a quantity of enabled or disabled TRPs; and a mode of the enabled or disabled TRP; and the first operation includes at least one of the following operations: monitoring or not monitoring a Physical Downlink Control Channel (PDCCH); performing or not performing rate matching; feeding back or not feeding back Hybrid Automatic Repeat reQuest ACKnowledgment (HARQ-ACK) information or a HARQ-ACK codebook; and determining Quasi-Co-Location (QCL) information of a Physical Downlink Shared Channel (PDSCH).

According to a second aspect, a transmission method is provided and applied to a network-side device. The method includes: sending, by the network-side device, first indication information to a terminal, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP.

According to a third aspect, a transmission apparatus is provided and includes: an obtaining module, configured to obtain first indication information; and an execution module, configured to perform a first operation based on the first indication information, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP; and the first operation includes at least one of the following operations: monitoring or not monitoring a PDCCH; performing or not performing rate matching; feeding back or not feeding back HARQ-ACK information or a HARQ-ACK codebook; and determining QCL information of a PDSCH.

According to a fourth aspect, a transmission apparatus is provided and includes: a sending module, configured to send first indication information to a terminal, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP.

According to a fifth aspect, a terminal is provided. The terminal includes a processor and a memory. The memory stores a program or instruction capable of running on the processor. When the program or instruction are executed by the processor, the steps of the transmission method according to the first aspect are implemented.

According to a sixth aspect, a terminal is provided and includes a processor and a communication interface. The communication interface is configured to obtain first indication information, and the processor is configured to perform a first operation based on the first indication information, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP; and the first operation includes at least one of the following operations: monitoring or not monitoring a PDCCH; performing or not performing rate matching; feeding back or not feeding back HARQ-ACK information or a HARQ-ACK codebook; and determining QCL information of a PDSCH.

According to a seventh aspect, a network-side device is provided. The network-side device includes a processor and a memory. The memory stores a program or instruction capable of running on the processor. When the program or instruction is executed by the processor, the steps of the transmission method according to the second aspect are implemented.

According to an eighth aspect, a network-side device is provided and includes a processor and a communication interface. The communication interface is configured to send first indication information to a terminal, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP.

According to a ninth aspect, a transmission system is provided and includes a terminal and a network-side device. The terminal may be configured to perform the steps of the transmission method according to the first aspect. The network-side device may be configured to perform the steps of the transmission method according to the second aspect.

According to a tenth aspect, a readable storage medium is provided. The readable storage medium stores a program or instruction. When the program or instruction is executed by a processor, the steps of the transmission method according to the first aspect are implemented, or the steps of the transmission method according to the second aspect are implemented.

According to an eleventh aspect, a chip is provided. The chip includes a processor and a communication interface. The communication interface is coupled to the processor. The processor is configured to run a program or instruction to implement the transmission method according to the first aspect or implement the transmission method according to the second aspect.

According to a twelfth aspect, a computer program or program product is provided. The computer program or program product is stored in a storage medium. The computer program or program product is executed by at least one processor to implement the steps of the transmission method according to the first aspect or implement the steps of the transmission method according to the second aspect.

In the embodiments of this application, the terminal obtains the first indication information, where the first indication information is used to indicate an energy saving or working mode of the network-side device, to dynamically indicate a multi-TRP working state of the network-side device; and the terminal performs a corresponding operation based on the first indication information. In this way, energy consumption of the terminal can be reduced.

### BRIEF DESCRIPTION OF DRAWINGS

FIG. 1 is a block diagram of a wireless communication system to which an embodiment of this application may be applied;

FIG. 2 is a schematic diagram of multi-panel transmission within a same TRP according to an embodiment of this application;

FIG. 3 is a schematic diagram of multi-TRP/panel transmission between multiple TRPs with an ideal backhaul according to an embodiment of this application;

FIG. 4 is a schematic diagram of multi-TRP/panel transmission between multiple TRPs with a non-ideal backhaul according to an embodiment of this application;

FIG. 5 is a first schematic flowchart of a transmission method according to an embodiment of this application;

FIG. 6 is a first schematic diagram of group common indication fields according to an embodiment of this application;

FIG. 7 is a second schematic diagram of group common indication fields according to an embodiment of this application;

FIG. 8 is a second schematic flowchart of a transmission method according to an embodiment of this application;

FIG. 9 is a schematic interaction diagram of a transmission method according to an embodiment of this application;

FIG. 10 is a first schematic diagram of a structure of a transmission apparatus according to an embodiment of this application;

FIG. 11 is a second schematic diagram of a structure of a transmission apparatus according to an embodiment of this application;

FIG. 12 is a schematic diagram of a structure of a communication device according to an embodiment of this application;

FIG. 13 is a schematic diagram of a hardware structure of a terminal for implementing an embodiment of this application; and

FIG. 14 is a schematic diagram of a structure of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “and/or” in the specification and claims indicates at least one of connected objects, and the character “/” generally represents an “or” relationship between associated objects.

It should be noted that technologies described in the embodiments of this application are not limited to a Long Term Evolution (LTE)/LTE-Advanced (LTE-A) system, and can also be used in other wireless communication systems, such as Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. The terms “system” and “network” in the embodiments of this application are usually used interchangeably. The described technologies may be used for the foregoing systems and radio technologies, and may also be used for other systems and radio technologies. However, in the following descriptions, the New Radio (NR) system is described for an illustrative purpose, and NR terms are used in most of the following descriptions. These technologies may also be applied to other applications than an NR system application, for example, a 6th Generation (6G) communication system.

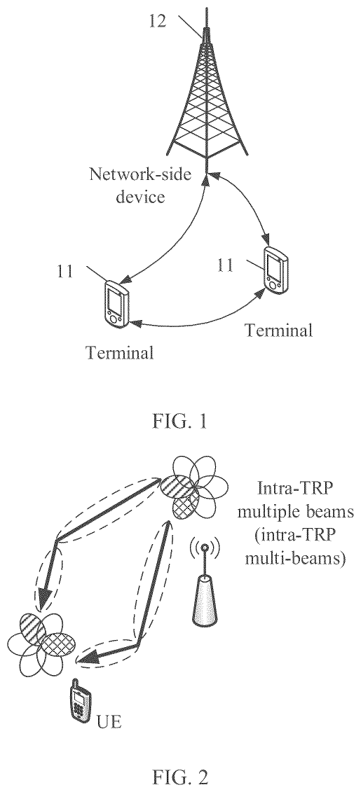

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR) or Virtual Reality (VR) device, a robot, a wearable device, Vehicle User Equipment (VUE), Pedestrian User Equipment (PUE), a smart home (a home device having a wireless communication function, such as a refrigerator, a television, a washing machine, or furniture), a game console, a Personal Computer (PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network element. The access network device may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home eNB, a TRP, or another appropriate term in the art. As long as the same technical effect is achieved, the base station is not limited to specific technical terms. It should be noted that in the embodiments of this application, only a base station in an NR system is used as an example for description, but a specific type of the base station is not limited.

The following first describes related content in this application.

### 1. Network Energy Saving

Network energy saving is very important for environmental sustainability, reducing impact (greenhouse gas emission) on the environment, and reducing operating costs. With popularity of 5G in all lines of business and industries and different geographical areas, to meet more advanced services and applications, such as very high data rate (such as XR) services, a network needs to be deployed more densely, and more antennas, a larger bandwidth, and more frequency bands need to be used. These dense deployments and use of large-scale devices pose a greater challenge to energy consumption of a 5G network device.

Energy consumption has become an important part of an OPEX of an operator. According to a report of GSMA, an energy cost of a mobile network accounts for about 23% of a total cost of the operator. Most energy consumption comes from a radio access network, for example, Active Antenna Units (AAU), where energy consumption of a data center and optical fiber transmission accounts for a small proportion. Power consumption of the radio access network may be divided into two parts: a dynamic part, that is, energy consumption in data transmission/reception; and a static part, that is, even if no data is transmitted/received, constant energy consumption is needed to maintain a necessary operation of a radio access device.

Therefore, impact of 5G on the environment needs to be controlled, and a new solution needs to be developed to improve a network energy-saving effect.

### 2. Multi-TRP

3GPP Rel-16 standardizes a multi-TRP/multi-panel scenario to improve transmission reliability and throughput performance. For example, UE can receive same data or different data from multiple TRPs. Several multi-TRP transmission scenarios are preliminarily discussed.
(1) Multi-panel transmission in a same TRP
(2) Multi-TRP/panel transmission between multiple TRPs with an ideal backhaul
(3) Multi-TRP/panel transmission between multiple TRPs with a non-ideal backhaul

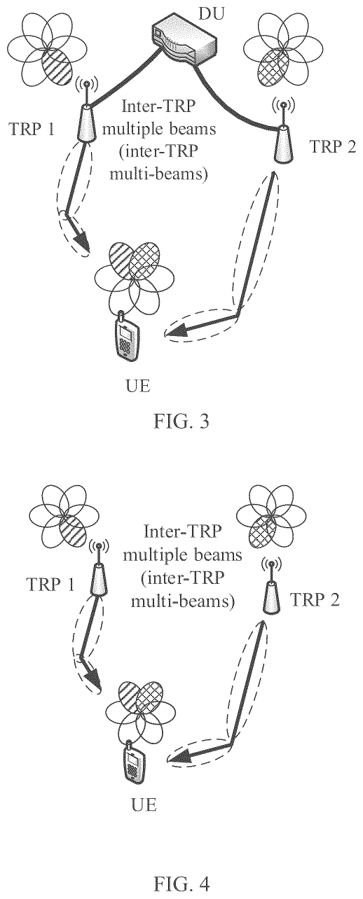

FIG. 2 to FIG. 4 show multi-TRP transmission scenarios. FIG. 2 is a schematic diagram of multi-panel transmission within a same TRP. FIG. 3 is a schematic diagram of multi-TRP/panel transmission between multiple TRPs with an ideal backhaul. FIG. 4 is a schematic diagram of multi-TRP/panel transmission between multiple TRPs with a non-ideal backhaul.

An ideal backhaul and a non-ideal backhaul may exist between the multiple TRPs.

In the non-ideal backhaul, a high latency exists in information exchange between the multiple TRPs, independent scheduling is appropriate, and an ACK/NACK and a Channel State Information (CSI) report are fed back to each TRP separately. Usually, this is applicable to multi Downlink Control Information (DCI) scheduling. In other words, each TRP transmits a PDCCH of the TRP, each PDCCH schedules a PDSCH of the TRP, and multiple CORESETs configured for the UE are associated with different RRC parameters CORESETPoolIndex and correspond to different TRPs. Multiple PDSCHs scheduled by multiple DCIs may not overlap or may partially overlap or entirely overlap on time-frequency resources. On overlapping time-frequency resources, each TRP performs independent precoding based on its own channel, and the UE receives multi-layer data streams of the multiple PDSCHs in Non-Coherent Joint Transmission (NCJT) mode.

In the ideal backhaul, scheduling information and UE feedback information can be exchanged between the multiple TRPs in real time. Not only the multiple PDSCHs can be scheduled by the multiple DCIs, but also a PDSCH can be scheduled by single DCI. The following transmission solutions are included. (1) Space Division Multiplexing (SDM): Different data layers of a same Transport Block (TB) are transmitted from different TRPs through NCJT. (2) Frequency Division Multiplexing (FDM): Different frequency domain resources to which a same Redundancy Version (RV) of a same TB is mapped are transmitted from different TRPs, or different RVs of a same TB are mapped to different frequency domain resources and transmitted from different TRPs. (3) Time Division Multiplexing (TDM): Different RVs of a same TB are repeated from different TRPs for multiple times, for example, repeated in one slot, or repeated in multiple slots. In this case, an ACK/NACK and a CSI report may be fed back to any TRP.

A transmission method provided in the embodiments of this application is hereinafter described in detail by using some embodiments and application scenarios thereof with reference to the accompanying drawings.

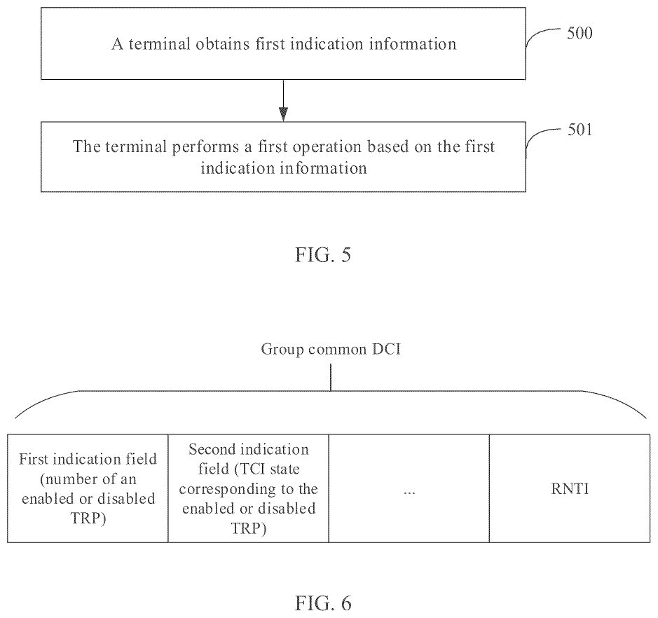

FIG. 5 is a first schematic flowchart of a transmission method according to an embodiment of this application. As shown in FIG. 5, the transmission method includes step 500 and step 501.

Step 500: A terminal obtains first indication information.

A network-side device indicates the first indication information to the terminal, and the terminal obtains the first indication information, where the first indication information is used to indicate an energy saving or working mode of the network-side device.

The obtaining may be understood as obtaining from a configuration, receiving, receiving after requesting, or obtaining after processing based on received information, which may be determined based on an actual requirement and is not limited in this embodiment of this application.

The first indication information includes at least one of the following.
(a) Number(s) of one or more CORESETs, or a quantity of one or more CORESETs, or number(s) of one or more CORESET pools.

It may be understood that the first indication information may include at least one of the number(s) and quantity of the one or more CORESETs. In some alternative embodiments, the first indication information includes the number(s) of the one or more CORESET pools.

It should be noted that the CORESET or CORESET pool indicated by the first indication information is in a correspondence with a TRP.

In some embodiments, the CORESET is in a correspondence with one or more TRPs, or the CORESET pool is in a correspondence with one or more TRPs. It may be understood that for the terminal, the terminal does not need to know whether a TRP is enabled or disabled, but only needs to perform a corresponding operation based on the first indication information.

In some embodiments, the CORESET is in a correspondence with an enabled or disabled TRP, or the CORESET pool is in a correspondence with an enabled or disabled TRP.

In other words, the CORESET or CORESET pool corresponds to the enabled or disabled TRP.
(b) One or more TCI states, or one or more TCI state sets.

It may be understood that because different TRPs correspond to different TCIs, the network-side device may indicate a corresponding TRP by indicating a TCI or a resource corresponding to a TCI.

In some embodiments, the TCI state is in a correspondence with one or more TRPs, or the TCI state set is in a correspondence with one or more TRPs.

In some embodiments, the TCI state is in a correspondence with an enabled or disabled TRP, or the TCI state set is in a correspondence with an enabled or disabled TRP.
(c) One or more time windows.

In some embodiments, the first indication information includes one or more time windows, and the time window corresponds to a time or a time unit within which a TRP is in an enabled state or a disabled state.

In some embodiments, the time window is in a correspondence with a TRP. For example, a time window 1 corresponds to a TRP 1, and a time window 2 corresponds to a TRP 2.
(d) A number of an enabled or disabled TRP, or a quantity of enabled or disabled TRPs.

It may be understood that the first indication information includes at least one of the numbers and quantity of the enabled or disabled TRPs.

For example, the first indication information indicates that the numbers of the enabled TRPs are TRP 1 and TRP 3.
(e) A mode of an enabled or disabled TRP.

For example, the mode of the enabled or disabled TRP is enable or disable for a period of T, that is, enable for a time T1 and disable for a time T2 each time.

In some embodiments, the modes of the enabled or disabled TRPs may be multiple modes, and each mode corresponds to a TRP. For example, a mode 1 corresponds to the TRP 1, and a mode 2 corresponds to the TRP 2.

For a period of each mode, an enabling time or a disabling time may be set independently.

For each mode, in each period, an enabling time T1 and a disabling time T2 are possible, or a disabling time T1 and an enabling time T2 are possible. T1 and T2 may be set independently as required.

In some embodiments, an indication granularity of the first indication information includes: per cell or per cell group.

In some embodiments, the number of the CORESET or CORESET pool may be explicitly indicated in the first indication information, or implicitly indicated by a CORESET or CORESET pool corresponding to a PDCCH that carries or schedules the first indication information; and
the TCI state may be explicitly indicated in the first indication information, or implicitly indicated by a TCI state corresponding to the CORESET or CORESET pool of the PDCCH that carries or schedules the first indication information.

In some embodiments, that a terminal obtains first indication information includes at least one of the following.
(1) The terminal receives RRC signaling, where the RRC signaling carries the first indication information.

In some embodiments, the RRC signaling includes a broadcast message or a dedicated RRC message.

In some embodiments, the dedicated RRC message may be an RRC release message.
(2) The terminal receives group common DCI, where the group common DCI includes one or more indication fields for indicating the first indication information.

In some embodiments, each indication field is applied to all terminals receiving the group common DCI, or each indication field is applied to one of a plurality of terminals receiving the group common DCI.

In some embodiments, using the group common DCI to indicate the first indication information is implemented in the following manners.

Manner 1: The group common DCI includes an indication field for indicating one piece of first indication information, and the indication field is applied to all terminals receiving the group common DCI.

FIG. 6 is a first schematic diagram of group common indication fields according to an embodiment of this application. As shown in FIG. 6, the group common DCI carries one piece of first indication information. The group common DCI includes a plurality of indication fields, each of the plurality of indication fields indicates one item of the first indication information, and each of the plurality of indication fields is applied to all terminals receiving the group common DCI.

Manner 2: The group common DCI includes indication fields for indicating one or more pieces of first indication information, each indication field indicates one piece of first indication information, and each indication field is applied to one of a plurality of terminals receiving the group common DCI. Each terminal reads an indication field in a corresponding position in the group common DCI based on configuration information of the network-side device.

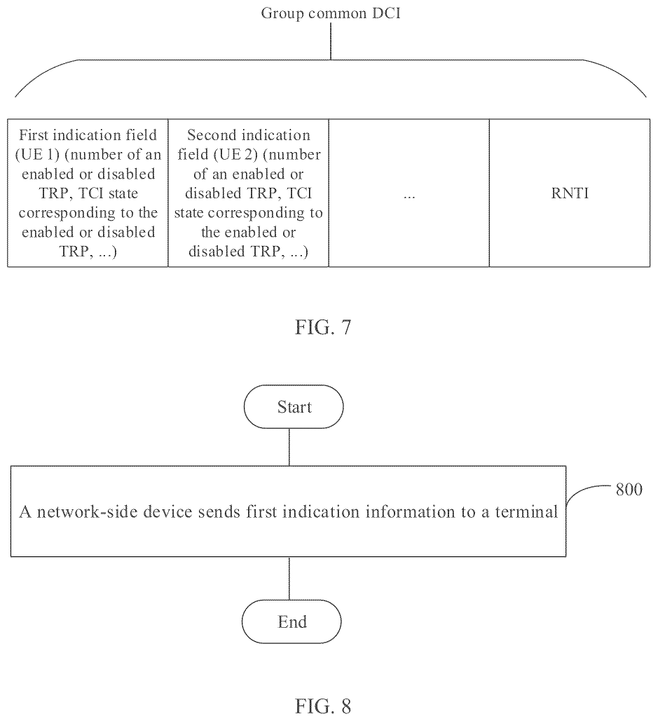

FIG. 7 is a second schematic diagram of group common indication fields according to an embodiment of this application. As shown in FIG. 7, the group common DCI includes a plurality of indication fields, each indication field indicates one piece of first indication information, and each indication field is applied to one of a plurality of terminals receiving the group common DCI.
(3) The terminal receives a Media Access Control Control Element (MAC CE), where the MAC CE includes one or more indication fields for indicating the first indication information.

In some embodiments, the MAC CE is sent by using a broadcast message or a multicast message.

In some embodiments, each indication field is applied to all terminals receiving the MAC CE, or each indication field is applied to one of a plurality of terminals receiving the MAC CE.

In some embodiments, using the MAC CE to indicate the first indication information is implemented in the following manners.

Manner 1: The MAC CE carries one piece of first indication information, the MAC CE includes one or more indication fields, each indication field indicates one item of the first indication information, and each indication field is applied to all terminals receiving the MAC CE.

Manner 2: The MAC CE includes indication fields for indicating one or more pieces of first indication information, each indication field indicates one piece of first indication information, and each indication field is applied to one of a plurality of terminals receiving the MAC CE. Each terminal reads an indication field in a corresponding position in the MAC CE based on configuration information of a network.

Step 501: The terminal performs a first operation based on the first indication information, where the first operation includes at least one of the following operations:
monitoring or not monitoring a PDCCH;
performing or not performing rate matching;
feeding back or not feeding back HARQ-ACK information or a HARQ-ACK codebook; and
determining QCL information of a PDSCH.

In this embodiment of this application, the terminal obtains the first indication information, where the first indication information is used to indicate the energy saving or working mode of the network-side device, to dynamically indicate a multi-TRP working state of the network-side device; and the terminal performs a corresponding operation based on the first indication information. In this way, energy consumption of the terminal can be reduced.

The following describes in detail the first operation performed by the terminal based on the first indication information.

### I. Monitoring the PDCCH

It may be understood that the terminal monitors or does not monitor the corresponding PDCCH based on the number of the CORESET or CORESET pool, or the TCI state or TCI state set, or the enabled or disabled TRP indicated by the first indication information.

In an implementation, the terminal monitors the corresponding PDCCH based on the CORESET or the CORESET pool indicated by the first indication information.

In other words, the terminal monitors the PDCCH in the CORESET or CORESET pool indicated by the first indication information.

In an implementation, the terminal monitors, based on all configured CORESETs or CORESET pools, a corresponding PDCCH in a remaining CORESET or CORESET pool other than the CORESET or the CORESET pool indicated by the first indication information.

In other words, the terminal does not monitor the PDCCH in the CORESET or CORESET pool indicated by the first indication information.

In an implementation, the terminal monitors a corresponding PDCCH in a first CORESET or CORESET pool based on the TCI state or the TCI state set indicated by the first indication information, where a TCI state of the first CORESET or CORESET pool is at least one of the indicated TCI state or TCI states in the indicated TCI state set.

It may be understood that the terminal determines the first CORESET or CORESET pool corresponding to the TCI state or the TCI state set indicated by the first indication information, and monitors the PDCCH in the first CORESET or CORESET pool.

In an implementation, the terminal monitors a corresponding PDCCH in a second CORESET or CORESET pool based on all configured or activated TCI states and the TCI state or the TCI state set indicated by the first indication information, where a TCI state of the second CORESET or CORESET pool is any one of remaining TCI states other than the indicated TCI state or those in the TCI state set among all the configured or activated TCI states.

In other words, the terminal does not monitor the PDCCH in the second CORESET or CORESET pool corresponding to the TCI state or the TCI state set indicated by the first indication information.

In an implementation, the terminal monitors, based on an enabled TRP indicated by the first indication information, a corresponding PDCCH in a CORESET corresponding to the enabled TRP.

In some embodiments, the terminal does not monitor, based on a disabled TRP indicated by the first indication information, a corresponding PDCCH in a CORESET corresponding to the disabled TRP.

In some embodiments, that the terminal performs a first operation based on the first indication information includes at least one of the following:
the terminal monitors, based on the time window indicated by the first indication information, a corresponding PDCCH within a time or time unit when a TRP is in an enabled state, or does not monitor a corresponding PDCCH within a time or time unit when a TRP is in a disabled state; and
the terminal monitors, based on the mode of the enabled or disabled TRP indicated by the first indication information, the corresponding PDCCH within the time or time unit when the TRP is in the enabled state, or does not monitor the corresponding PDCCH within the time or time unit when the TRP is in the disabled state.

For example, the network-side device configures a plurality of CORESETs by using PDCCH-config, where each CORESET is configured with a different CORESETPoolIndex, and each CORESETPoolIndex corresponds to one TRP. Assuming that the network configuration enables the TRP 1 and the TRP 2, corresponding CORESETPoolIndex=0 and CORESETPoolIndex=1. When the terminal receives the first indication information indicating a number of the disabled TRP (or a number of a CORESET pool corresponding to the disabled TRP), if the number of the disabled TRP is TRP 2, the terminal does not monitor the PDCCH in a CORESET corresponding to the TRP 2 (that is, CORESETPoolIndex=1).

In some embodiments, the method further includes:
the terminal determines a quantity of candidate PDCCHs based on the CORESET or control resource set pool, or the TCI state or TCI state set, or the enabled or disabled TRP that is indicated by the first indication information.

It should be noted that when the terminal determines the quantity of candidate PDCCHs, the terminal only considers a PDCCH monitoring occasion corresponding to the number of the indicated CORESET or CORESET pool, or a PDCCH monitoring occasion corresponding to the TCI state or TCI state set, or a PDCCH monitoring occasion corresponding to the enabled TRP.

The foregoing operation may be applied to a common search space and/or a UE-specific search space.

### II. Rate Matching

In some embodiments, that the terminal performs a first operation based on the first indication information includes:
the terminal performs or does not perform rate matching on the PDSCH on a first resource based on the CORESET or CORESET pool, or the TCI state or TCI state set, or the enabled or disabled TRP that is indicated by the first indication information.

In an implementation, the first resource is a resource determined by the terminal based on a rate matching pattern configured by the network.

For example, the first resource is a resource determined based on a Common Reference Signal (CRS) pattern configured by the network, where the CRS is a reference signal in LTE.

In some embodiments, the first resource is a resource corresponding to a rate matching pattern associated with the indicated CORESET or CORESET pool, or TCI state or TCI state set, or enabled or disabled TRP.

In other words, the first resource is the resource corresponding to the rate matching pattern, where the rate matching pattern corresponds to the CORESET or CORESET pool, the TCI state or TCI state set, or the enabled or disabled TRP that is indicated by the first indication information.

For example, assuming that the network configuration enables the TRP 1 and the TRP 2, and that the corresponding CORESETPoolIndex=0 and CORESETPoolIndex=1, when an association between a rate matching pattern 1 and the TRP 1 (CORESETPoolIndex=0), and an association between a rate matching pattern 2 and the TRP 2 (CORESETPoolIndex=1) are configured for the terminal, when the terminal receives the first indication information indicating the number of the disabled TRP (or the number of the CORESET pool corresponding to the disabled TRP), for example, the number of the disabled TRP is TRP 1, the terminal performs rate matching on the PDSCH on a resource corresponding to the rate matching pattern 2. In this case, the terminal does not need to perform rate matching on the PDSCH on a resource corresponding to the rate matching pattern 1.

### III. Determining and Feeding Back the HARQ-ACK Information or the HARQ-ACK Codebook

In some embodiments, that the terminal performs a first operation based on the first indication information includes at least one of the following:
the terminal feeds back or does not feed back first HARQ-ACK information or a first HARQ-ACK codebook based on the CORESET or CORESET pool, or the TCI state or TCI state set, or the enabled or disabled TRP that is indicated by the first indication information, where the first HARQ-ACK information or first HARQ-ACK codebook is associated with the indicated CORESET or CORESET pool, or TCI state or TCI state set, or enabled or disabled TRP.

It should be noted that a priority corresponding to the first HARQ-ACK information or first HARQ-ACK codebook may be a low priority or a high priority; and a transmission resource for the first HARQ-ACK information or first HARQ-ACK codebook may be a PUCCH or a PUSCH.

In some embodiments, that the first HARQ-ACK information or first HARQ-ACK codebook is associated with the indicated CORESET or CORESET pool, or TCI state or TCI state set, or enabled or disabled TRP includes at least one of the following.
(a) The first HARQ-ACK information or first HARQ-ACK codebook is associated with the indicated CORESET or CORESET pool, where the CORESET or CORESET pool is used to receive the PDCCH for scheduling the feedback of the first HARQ-ACK information or first HARQ-ACK codebook.

It may be understood that the CORESET or CORESET pool indicated by the first indication information is associated with the first HARQ-ACK information or first HARQ-ACK codebook, and that the CORESET or CORESET pool is used to receive the PDCCH for scheduling the feedback of the first HARQ-ACK information or first HARQ-ACK codebook.
(b) The first HARQ-ACK information or first HARQ-ACK codebook is associated with a third CORESET or CORESET pool, where a TCI state of the third CORESET or CORESET pool is the indicated TCI state, and the third CORESET or CORESET pool is used to receive the PDCCH for scheduling the feedback of the first HARQ-ACK information or first HARQ-ACK codebook.

It may be understood that the third CORESET or CORESET pool corresponding to the TCI state or the TCI state set indicated by the first indication information is associated with the first HARQ-ACK information or first HARQ-ACK codebook, and that the third CORESET or CORESET pool is used to receive the PDCCH for scheduling the feedback of the first HARQ-ACK information or first HARQ-ACK codebook.
(c) The first HARQ-ACK information or first HARQ-ACK codebook is associated with a fourth CORESET or CORESET pool, where the fourth CORESET or CORESET pool corresponds to a first TRP, and the fourth CORESET or CORESET pool is used to receive the PDCCH for scheduling the feedback of the first HARQ-ACK information or first HARQ-ACK codebook.

It may be understood that the first HARQ-ACK information or first HARQ-ACK codebook is associated with the fourth CORESET or CORESET pool, where the fourth CORESET or CORESET pool corresponds to a TRP, the TRP is denoted as the first TRP, and the fourth CORESET or CORESET pool is used to receive the PDCCH for scheduling the feedback of the first HARQ-ACK information or first HARQ-ACK codebook.

In some embodiments, the not feeding back first HARQ-ACK information or a first HARQ-ACK codebook includes at least one of the following:
the terminal determines the disabled TRP based on the CORESET or CORESET pool, or the TCI state or TCI state set that is indicated by the first indication information, and does not generate HARQ-ACK information or a HARQ-ACK codebook of the PDSCH corresponding to the disabled TRP; and
the terminal does not generate, based on the disabled TRP indicated by the first indication information, the HARQ-ACK information or HARQ-ACK codebook of the PDSCH corresponding to the disabled TRP.

In some embodiments, for the disabled TRP, predefined HARQ-ACK information or a predefined HARQ-ACK codebook, such as predefined bit information and a predefined size, may also be fed back.

For example, a NACK, or an ACK, or Discontinuous Transmission (DTX) may be fed back.

In some embodiments, when the network-side device configures a separate HARQ-ACK codebook, different HARQ-ACK codebooks are generated for different CORESETs or CORESET pools or TRPs. If the terminal receives the first indication information indicating the number of the CORESET or CORESET pool, or the TCI state or TCI state set, or the enabled or disabled TRP, or the number of the disabled TRP (or the number of the CORESET or CORESET pool corresponding to the disabled TRP), the terminal does not generate a HARQ-ACK codebook for the disabled TRP determined based on the first indication information.

In some embodiments, when the network configures a joint HARQ-ACK codebook, HARQ-ACK information corresponding to different TRPs is concatenated in a same HARQ-ACK codebook. If the terminal receives the first indication information indicating the number of the CORESET or CORESET pool, or the TCI state or TCI state set, or the enabled or disabled TRP, or the number of the disabled TRP (or the number of the CORESET or CORESET pool corresponding to the disabled TRP), the terminal does not generate HARQ-ACK information for the disabled TRP determined based on the first indication information.

Further, only a PDCCH monitoring occasion corresponding to an enabled CORESET or CORESET pool or TRP is considered for a counter Downlink Assignment Indicator ( ) and/or total DCI.

In the foregoing embodiments, the HARQ-ACK codebook includes a semi-static codebook (Type 1 HARQ-ACK codebook) or a dynamic codebook (Type 2 HARQ-ACK codebook).

In some embodiments, in the foregoing embodiments, the HARQ-ACK codebook may be a type 3 HARQ-ACK codebook, where the codebook includes HARQ-ACK information of one or more HARQ process numbers.

### IV. Determining the Quasi-Co-Location QCL Information of the PDSCH

In some embodiments, that the terminal performs a first operation based on the first indication information includes:
the terminal determines a target CORESET or CORESET pool based on the CORESET or the CORESET pool indicated by the first indication information; and
determines QCL information of a Demodulation Reference Signal (DMRS) port of the PDSCH based on a QCL parameter of the target CORESET or CORESET pool, where
the target CORESET or CORESET pool is a CORESET or CORESET pool with a largest or smallest number among the numbers of the indicated CORESETs or CORESET pools; or
the target CORESET or CORESET pool is a CORESET or CORESET pool with a largest or smallest number among remaining CORESETs or CORESET pools other than the indicated CORESETs or CORESET pools based on all CORESETs or CORESET pools.

It may be understood that, in a case that the first indication information indicates at least one of the numbers and quantity of CORESETs or CORESET pools, the terminal determines the CORESET with the largest or smallest number among the indicated CORESETs as the target CORESET, or the terminal determines the CORESET pool with the largest or smallest number among the indicated CORESET pools as the target CORESET pool.

In some embodiments, the terminal determines, based on all configured CORESETs, the CORESET with the largest or smallest number among the remaining CORESETs other than the CORESETs indicated by the first indication information, as the target CORESET. In some alternative embodiments, the terminal determines, based on all configured CORESET pools, the CORESET pool with the largest or smallest number among the remaining CORESET pools other than the CORESET pools indicated by the first indication information, as the target CORESET pool.

Further, the terminal determines the QCL information of the DMRS port of the PDSCH based on the QCL parameter of the target CORESET. In some alternative embodiments, the terminal determines the QCL information of the DMRS port of the PDSCH based on the QCL parameter of the target CORESET pool.

In some embodiments, that the terminal performs a first operation based on the first indication information includes:

the terminal determines a target TCI state or TCI state set based on the TCI state or the TCI state set indicated by the first indication information; and

determines QCL information of a DMRS port of the PDSCH based on a QCL parameter of a CORESET or CORESET pool corresponding to the target TCI state or TCI state set, where the target TCI state or TCI state set is a TCI state or TCI state set with a largest or smallest number among the indicated TCI states or TCI state sets; or the target TCI state or TCI state set is a TCI state or TCI state set with a largest or smallest number among remaining TCI states or TCI state sets other than the indicated TCI states or TCI state sets based on all configured TCI states or TCI state sets.

It may be understood that, in a case that the first indication information indicates TCI states or TCI state sets, the terminal determines the TCI state with the largest or smallest number among the indicated TCI states as the target TCI state, or the terminal determines the TCI state set with the largest or smallest number among the indicated TCI state sets as the target TCI state set.

In some embodiments, the terminal determines, based on all configured or activated TCI states, the TCI state with the largest or smallest number among the remaining TCI states other than the TCI states indicated by the first indication information, as the target TCI state. In some alternative embodiments, the terminal determines, based on all configured or activated TCI state sets, the TCI state set with the largest or smallest number among the remaining TCI state sets other than the TCI state sets indicated by the first indication information, as the target TCI state set.

Further, the terminal determines the QCL information of the DMRS port of the PDSCH based on the QCL parameter of the CORESET corresponding to the target TCI state or TCI state set. In some alternative embodiments, the terminal determines the QCL information of the DMRS port of the PDSCH based on the QCL parameter of the CORESET pool corresponding to the target TCI state or TCI state set.

In some embodiments, that the terminal performs a first operation based on the first indication information includes:
the terminal determines, based on the enabled TRP indicated by the first indication information, a CORESET with a largest or smallest number and corresponding to the enabled TRP; and
determines QCL information of a DMRS port of the PDSCH based on a QCL parameter of the CORESET with the largest or smallest number and corresponding to the enabled TRP.

It should be noted that the foregoing embodiments of determining the QCL information of the DMRS port of the PDSCH all meet a time relationship, that is, a time interval between a receiving time of the PDCCH and a receiving time of the corresponding PDSCH is less than or equal to a preset value.

In some embodiments, the method further includes:
before the first indication information takes effect, the terminal receives second indication information, where the second indication information is used to indicate a plurality of TCI states, and the plurality of TCI states correspond to all configured TRPs, where
all the configured TRPs include the enabled and disabled TRPs,
the second indication information may be carried by DCI; and
the terminal determines, based on a first or last TCI state among the plurality of TCI states indicated by the second indication information, a TCI state corresponding to downlink transmission.

It may be understood that before the first indication information takes effect, if the terminal receives the second indication information indicating the plurality of TCI states, the terminal needs to determine, based on the second indication information, the TCI state corresponding to the downlink transmission.

The terminal determines the first or last TCI state among the plurality of TCI states indicated by the second indication information, as the TCI state corresponding to the downlink transmission, where the first or last TCI state among the plurality of TCI states is a TCI state corresponding to the enabled TRP.

In some embodiments, the terminal does not expect to receive second indication information, the second indication information is used to indicate a plurality of TCI states, and the plurality of TCI states include a TCI state corresponding to the disabled TRP.

In some embodiments, the terminal does not expect to receive second indication information, and number(s) of one or more CORESETs or CORESET pools, or TCI states or TCI state sets, or numbers of TRPs that are indicated by the second indication information correspond to the number(s) of the one or more CORESETs or CORESET pools, or TCI states or TCI state sets, or numbers of TRPs that are indicated by the first indication information.

In some embodiments, the number(s) of the one or more CORESETs or CORESET pools, or TCI states or TCI state sets, or numbers of TRPs that are indicated by the first indication information correspond to the disabled TRP.

For example, the numbers of the CORESETs or CORESET pools include the CORESET or CORESET pool corresponding to the disabled TRP; and the TCI states include the TCI state corresponding to the disabled TRP.

In some embodiments, the terminal does not expect to receive second indication information, the second indication information is used to indicate receiving of the PDSCH or a CSI-RS, or sending of the PUSCH or PUCCH or an SRS.

The PDSCH or CSI-RS and the number of the CORESET or CORESET pool indicated by the first indication information or the TCI state or the TCI state set indicated by the first indication information are QCL, where the number of the CORESET or CORESET pool or the TCI state or TCI state set corresponds to the disabled TRP.

The PUSCH or PUCCH or SRS and the TCI corresponding to the CORESET or CORESET pool indicated by the first indication information or the TCI state or the TCI state set indicated by the first indication information are QCL, where the number of the CORESET or CORESET pool or the TCI state or TCI state set corresponds to the disabled TRP.

The foregoing embodiments of this application may be used for Frequency-Division Duplex (FDD) and Time-Division Duplex (TDD) spectrums, and may be used for licensed frequency bands and unlicensed frequency bands, and may also be used for single-carrier and multi-carrier scenarios. This is not limited in the embodiments of this application.

According to the transmission method provided in this embodiment of this application, the TRP working state indicated by the network-side device can be dynamically obtained, so that the terminal can perform one or more corresponding operations of PDCCH monitoring, PDSCH rate matching, HARQ-ACK feedback, and QCL determining based on the dynamic indication, thereby effectively reducing energy consumption of the terminal.

FIG. 8 is a second schematic flowchart of a transmission method according to an embodiment of this application. As shown in FIG. 8, the transmission method includes the following step.

Step 800: A network-side device sends first indication information to a terminal.

The network-side device indicates the first indication information to the terminal, where the first indication information is used to indicate an energy saving or working mode of the network-side device.

In some embodiments, in a case that the network-side device configures a multi-TRP transmission mode, the network-side device sends the first indication information to the terminal. It should be noted that when working in other transmission modes, the network-side device may also send the first indication information to the terminal. This is not limited in this application.

The first indication information includes at least one of the following:
(a) Number(s) of one or more CORESETs, or a quantity of one or more CORESETs, or number(s) of one or more control resource set pools CORESET pools.

It may be understood that the first indication information may include at least one of the number(s) and quantity of the one or more CORESETs. In some alternative embodiments, the first indication information includes the number(s) of the one or more CORESET pools.

It should be noted that the CORESET or CORESET pool indicated by the first indication information is in a correspondence with a TRP.

In some embodiments, the CORESET is in a correspondence with one or more TRPs, or the CORESET pool is in a correspondence with one or more TRPs. It may be understood that for the terminal, the terminal does not need to know whether a TRP is enabled or disabled, but only needs to perform a corresponding operation based on the first indication information.

In some embodiments, the CORESET is in a correspondence with an enabled or disabled TRP, or the CORESET pool is in a correspondence with an enabled or disabled TRP.

In other words, the CORESET or CORESET pool corresponds to the enabled or disabled TRP.
(b) One or more TCI states, or one or more TCI state sets.

It may be understood that because different TRPs correspond to different TCIs, the network-side device may indicate a corresponding TRP by indicating a TCI or a resource corresponding to a TCI.

In some embodiments, the TCI state is in a correspondence with one or more TRPs, or the TCI state set is in a correspondence with one or more TRPs.

In some embodiments, the TCI state is in a correspondence with an enabled or disabled TRP, or the TCI state set is in a correspondence with an enabled or disabled TRP.
(c) One or more time windows.

In some embodiments, the first indication information includes one or more time windows, and the time window corresponds to a time or a time unit within which a TRP is in an enabled state or a disabled state.

In some embodiments, the time window is in a correspondence with a TRP. For example, a time window 1 corresponds to a TRP 1, and a time window 2 corresponds to a TRP 2.
(d) A number of an enabled or disabled TRP, or a quantity of enabled or disabled TRPs.

It may be understood that the first indication information includes at least one of the numbers and quantity of the enabled or disabled TRPs.

For example, the first indication information indicates that the numbers of the enabled TRPs are TRP 1 and TRP 3.
(e) A mode of an enabled or disabled TRP.

For example, the mode of the enabled or disabled TRP is enable or disable for a period of T, that is, enable for a time T1 and disable for a time T2 each time.

In some embodiments, the modes of the enabled or disabled TRPs may be multiple modes, and each mode corresponds to a TRP. For example, a mode 1 corresponds to the TRP 1, and a mode 2 corresponds to the TRP 2.

For a period of each mode, an enabling time or a disabling time may be set independently.

For each mode, in each period, an enabling time T1 and a disabling time T2 are possible, or a disabling time T1 and an enabling time T2 are possible. T1 and T2 may be set independently as required.

In some embodiments, an indication granularity of the first indication information includes: per cell or per cell group.
In some embodiments, the number of the CORESET or CORESET pool may be explicitly indicated in the first indication information, or implicitly indicated by a CORESET or CORESET pool corresponding to a PDCCH that carries or schedules the first indication information; and
the TCI state may be explicitly indicated in the first indication information, or implicitly indicated by a TCI state corresponding to the CORESET or CORESET pool of the PDCCH that carries or schedules the first indication information.

In this embodiment of this application, the network-side device sends the first indication information to the terminal, where the first indication information is used to indicate the energy saving or working mode of the network-side device, to dynamically indicate a multi-TRP working state of the network-side device to the terminal; and the terminal performs a corresponding operation based on the first indication information. In this way, energy consumption of the terminal can be reduced.

In some embodiments, that a network-side device sends first indication information includes at least one of the following.
(1) The network-side device sends RRC signaling, where the RRC signaling carries the first indication information.

In some embodiments, the RRC signaling includes a broadcast message or a dedicated RRC message.

In some embodiments, the dedicated RRC message may be an RRC release message.
(2) The network-side device sends group common DCI, where the group common DCI includes one or more indication fields for indicating the first indication information.

In some embodiments, each indication field is applied to all terminals receiving the group common DCI, or each indication field is applied to one of a plurality of terminals receiving the group common DCI.

Using the group common DCI to indicate the first indication information is implemented in the following manners.

Manner 1: The group common DCI includes an indication field for indicating one piece of first indication information, and the indication field is applied to all terminals receiving the group common DCI.

Manner 2: The group common DCI includes indication fields for indicating one or more pieces of first indication information, each indication field indicates one piece of first indication information, and each indication field is applied to one of a plurality of terminals receiving the group common DCI. Each terminal reads an indication field in a corresponding position in the group common DCI based on configuration information of the network-side device.
(3) The network-side device sends a media access control control element MAC CE, where the MAC CE includes one or more indication fields for indicating the first indication information.

In some embodiments, the MAC CE is sent by using a broadcast message or a multicast message.

In some embodiments, each indication field is applied to all terminals receiving the MAC CE, or each indication field is applied to one of a plurality of terminals receiving the MAC CE.

In some embodiments, using the MAC CE to indicate the first indication information is implemented in the following manners.

Manner 1: The MAC CE carries one piece of first indication information, the MAC CE includes one or more indication fields, each indication field indicates one item of the first indication information, and each indication field is applied to all terminals receiving the MAC CE.

Manner 2: The MAC CE includes indication fields for indicating one or more pieces of first indication information, each indication field indicates one piece of first indication information, and each indication field is applied to one of a plurality of terminals receiving the MAC CE. Each terminal reads an indication field in a corresponding position in the MAC CE based on configuration information of a network.

According to the transmission method provided in this embodiment of this application, the TRP working state of the network-side device can be dynamically indicated, so that the terminal can perform one or more corresponding operations of PDCCH monitoring, PDSCH rate matching, HARQ-ACK feedback, and QCL determining based on the dynamic indication, thereby reducing energy consumption of the network-side device and the terminal.

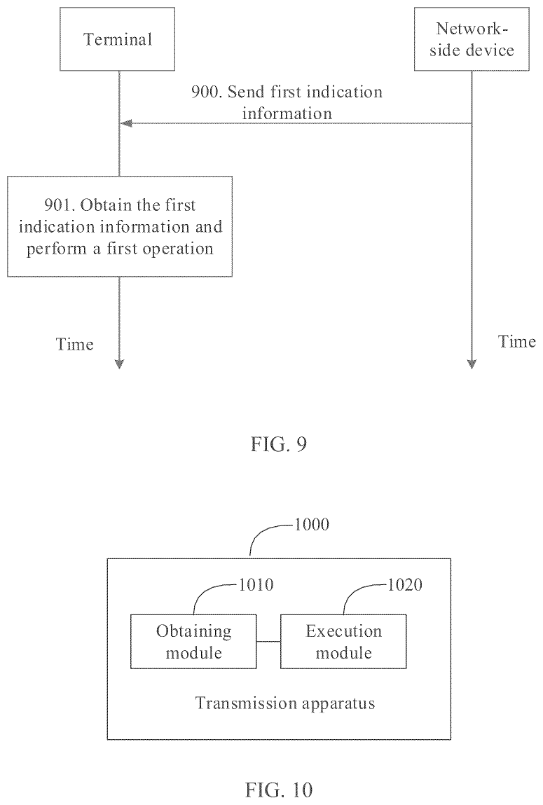

FIG. 9 is a schematic interaction diagram of a transmission method according to an embodiment of this application. As shown in FIG. 9, the method includes the following steps.

Step 900: A network-side device sends first indication information.

Step 901: A terminal obtains the first indication information and performs a first operation, where
the first indication information includes at least one of the following:
number(s) of one or more CORESETs, or a quantity of one or more CORESETs, or number(s) of one or more CORESET pools;
one or more TCI states, or one or more TCI state sets;
one or more time windows;
a number of an enabled or disabled TRP, or a quantity of enabled or disabled TRPs; and
a mode of an enabled or disabled TRP; and
the first operation includes at least one of the following operations:
monitoring or not monitoring a PDCCH;
performing or not performing rate matching;
feeding back or not feeding back HARQ-ACK information or a HARQ-ACK codebook; and
determining quasi-co-location QCL information of a physical downlink shared channel PDSCH.

The transmission method provided in this embodiment of this application may be performed by a transmission apparatus. A transmission apparatus provided in an embodiment of this application is described by assuming that the transmission apparatus performs the transmission method in this embodiment of this application.

FIG. 10 is a first schematic diagram of a structure of a transmission apparatus according to an embodiment of this application. As shown in FIG. 10, the transmission apparatus 1000 includes:
an obtaining module 1010, configured to obtain first indication information; and
an execution module 1020, configured to perform a first operation based on the first indication information, where
the first indication information includes at least one of the following:
number(s) of one or more CORESETs, or a quantity of one or more CORESETs, or number(s) of one or more pools;
one or more TCI states, or one or more TCI state sets;
one or more time windows;
a number of an enabled or disabled TRP, or a quantity of enabled or disabled TRPs; and
a mode of an enabled or disabled TRP; and
the first operation includes at least one of the following operations:
monitoring or not monitoring a PDCCH;
performing or not performing rate matching;
feeding back or not feeding back HARQ-ACK information or a HARQ-ACK codebook; and
determining quasi-co-location QCL information of a physical downlink shared channel PDSCH.

In this embodiment of this application, the transmission apparatus obtains the first indication information, where the first indication information is used to indicate an energy saving or working mode of the network-side device, to dynamically indicate a multi-TRP working state of the network-side device; and the transmission apparatus performs the corresponding operation based on the first indication information. In this way, energy consumption of a terminal can be reduced.

In some embodiments, the CORESET is in a correspondence with one or more TRPs, or the CORESET pool is in a correspondence with one or more TRPs.

In some embodiments, the CORESET is in a correspondence with an enabled or disabled TRP, or the CORESET pool is in a correspondence with an enabled or disabled TRP.

In some embodiments, the TCI state is in a correspondence with one or more TRPs, or the TCI state set is in a correspondence with one or more TRPs.

In some embodiments, the TCI state is in a correspondence with an enabled or disabled TRP, or the TCI state set is in a correspondence with an enabled or disabled TRP.

In some embodiments, the time window corresponds to a time or a time unit within which a TRP is in an enabled state or a disabled state.

In some embodiments, an indication granularity of the first indication information includes: per cell or per cell group.

In some embodiments, the obtaining module 1010 is configured to perform at least one of the following:
receiving radio resource control RRC signaling, where the RRC signaling carries the first indication information;
receiving group common downlink control information DCI, where the group common DCI includes one or more indication fields for indicating the first indication information, and each indication field is applied to all terminals receiving the group common DCI, or each indication field is applied to one of a plurality of terminals receiving the group common DCI; and receiving a media access control control element MAC CE, where the MAC CE includes one or more indication fields for indicating the first indication information, and each indication field is applied to all terminals receiving the MAC CE, or each indication field is applied to one of a plurality of terminals receiving the MAC CE.

In some embodiments, the execution module 1020 is configured to perform at least one of the following:
monitoring the corresponding PDCCH based on the CORESET or the CORESET pool indicated by the first indication information; and
monitoring, based on all configured CORESETs or CORESET pools, a corresponding PDCCH in a remaining CORESET or CORESET pool other than the CORESET or the CORESET pool indicated by the first indication information.

In some embodiments, the execution module 1020 is configured to perform at least one of the following:
monitoring a corresponding PDCCH in a first CORESET or CORESET pool based on the TCI state or the TCI state set indicated by the first indication information, where a TCI state of the first CORESET or CORESET pool is at least one of the indicated TCI state or TCI states in the indicated TCI state set; and monitoring a corresponding PDCCH in a second CORESET or CORESET pool based on all configured or activated TCI states and the TCI state or the TCI state set indicated by the first indication information, where a TCI state of the second CORESET or CORESET pool is any one of remaining TCI states other than the indicated TCI state or those in the TCI state set among all the configured or activated TCI states.

In some embodiments, the execution module 1020 is configured to perform at least one of the following:
monitoring, based on an enabled TRP indicated by the first indication information, a corresponding PDCCH in a CORESET corresponding to the enabled TRP; and
not monitoring, based on a disabled TRP indicated by the first indication information, a corresponding PDCCH in a CORESET corresponding to the disabled TRP.

In some embodiments, the execution module 1020 is configured to perform at least one of the following:
monitoring, based on the time window indicated by the first indication information, a corresponding PDCCH within a time or time unit when a TRP is in an enabled state, or not monitoring a corresponding PDCCH within a time or time unit when a TRP is in a disabled state; and
monitoring, based on the mode of the enabled or disabled TRP indicated by the first indication information, the corresponding PDCCH within the time or time unit when the TRP is in the enabled state, or not monitoring the corresponding PDCCH within the time or time unit when the TRP is in the disabled state.

In some embodiments, the execution module 1020 is configured to perform at least one of the following:
performing or not performing rate matching on the PDSCH on a first resource based on the CORESET or CORESET pool, or the TCI state or TCI state set, or the enabled or disabled TRP that is indicated by the first indication information.

In some embodiments, the first resource is a resource determined by the terminal based on a rate matching pattern configured by a network; or
the first resource is a resource corresponding to a rate matching pattern associated with the indicated CORESET or CORESET pool, or TCI state or TCI state set, or enabled or disabled TRP.

In some embodiments, the execution module 1020 is configured to perform at least one of the following:
feeding back or not feeding back first HARQ-ACK information or a first HARQ-ACK codebook based on the CORESET or CORESET pool, or the TCI state or TCI state set, or the enabled or disabled TRP that is indicated by the first indication information, where
the first HARQ-ACK information or first HARQ-ACK codebook is associated with the indicated CORESET or CORESET pool, or TCI state or TCI state set, or enabled or disabled TRP.

In some embodiments, that the first HARQ-ACK information or first HARQ-ACK codebook is associated with the indicated CORESET or CORESET pool, or TCI state or TCI state set, or enabled or disabled TRP includes at least one of the following:
the first HARQ-ACK information or first HARQ-ACK codebook is associated with the indicated CORESET or CORESET pool, where the CORESET or CORESET pool is used to receive the PDCCH for scheduling the feedback of the first HARQ-ACK information or first HARQ-ACK codebook;
the first HARQ-ACK information or first HARQ-ACK codebook is associated with a third CORESET or CORESET pool, where a TCI state of the third CORESET or CORESET pool is the indicated TCI state, and the third CORESET or CORESET pool is used to receive the PDCCH for scheduling the feedback of the first HARQ-ACK information or first HARQ-ACK codebook; and
the first HARQ-ACK information or first HARQ-ACK codebook is associated with a fourth CORESET or CORESET pool, where the fourth CORESET or CORESET pool corresponds to a first TRP, and the fourth CORESET or CORESET pool is used to receive the PDCCH for scheduling the feedback of the first HARQ-ACK information or first HARQ-ACK codebook.

In some embodiments, the not feeding back first HARQ-ACK information or a first HARQ-ACK codebook includes at least one of the following:
determining the disabled TRP based on the CORESET or CORESET pool, or the TCI state or TCI state set that is indicated by the first indication information, and not generating HARQ-ACK information or a HARQ-ACK codebook of the PDSCH corresponding to the disabled TRP;
and not generating, based on the disabled TRP indicated by the first indication information, the HARQ-ACK information or HARQ-ACK codebook of the PDSCH corresponding to the disabled TRP.

In some embodiments, the HARQ-ACK codebook includes a semi-static codebook or
a dynamic codebook.

In some embodiments, the execution module 1020 is configured to:
determine a target CORESET or CORESET pool based on the CORESET or the CORESET pool indicated by the first indication information; and
determine QCL information of a demodulation reference signal DMRS port of the PDSCH based on a QCL parameter of the target CORESET or CORESET pool, where
the target CORESET or CORESET pool is a CORESET or CORESET pool with a largest or smallest number among the numbers of the indicated CORESETs or CORESET pools; or
the target CORESET or CORESET pool is a CORESET or CORESET pool with a largest or smallest number among remaining CORESETs or CORESET pools other than the indicated CORESETs or CORESET pools based on all configured CORESETs or CORESET pools.

In some embodiments, the execution module 1020 is configured to:
determine a target TCI state or TCI state set based on the TCI state or the TCI state set indicated by the first indication information; and
determine QCL information of a DMRS port of the PDSCH based on a QCL parameter of a CORESET or CORESET pool corresponding to the target TCI state or TCI state set, where
the target TCI state or TCI state set is a TCI state or TCI state set with a largest or smallest number among the indicated TCI states or TCI state sets; or
the target TCI state or TCI state set is a TCI state or TCI state set with a largest or smallest number among remaining TCI states or TCI state sets other than the indicated TCI states or TCI state sets based on all configured or activated TCI states or TCI state sets.

In some embodiments, the execution module 1020 is configured to:
determine, based on the enabled TRP indicated by the first indication information, a CORESET with a largest or smallest number and corresponding to the enabled TRP; and
determine QCL information of a DMRS port of the PDSCH based on a QCL parameter of the CORESET with the largest or smallest number and corresponding to the enabled TRP.

In some embodiments, the apparatus further includes:
a first receiving module, configured to receive second indication information before the first indication information takes effect, where the second indication information is used to indicate a plurality of TCI states, and the plurality of TCI states correspond to all configured TRPs; and
a first determining module, configured to determine, based on a first or last TCI state among the plurality of TCI states indicated by the second indication information, a TCI state corresponding to downlink transmission, where
the first or last TCI state among the plurality of TCI states is a TCI state corresponding to the enabled TRP.

In some embodiments, the transmission apparatus does not expect to receive second indication information, the second indication information is used to indicate a plurality of TCI states, and the plurality of TCI states include a TCI state corresponding to the disabled TRP.

The transmission apparatus provided in this embodiment of this application can dynamically obtain the TRP working state indicated by the network-side device, and perform one or more corresponding operations of PDCCH monitoring, PDSCH rate matching, HARQ-ACK feedback, and QCL determining based on the dynamic indication, thereby effectively reducing energy consumption of the transmission apparatus.

The transmission apparatus in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a Network Attached Storage (NAS), and the like. This is not specifically limited in this embodiment of this application.

The transmission apparatus provided in this embodiment of this application can implement each process implemented in the method embodiments in FIG. 5 to FIG. 7, with the same technical effect achieved. To avoid repetition, details are not described herein again.

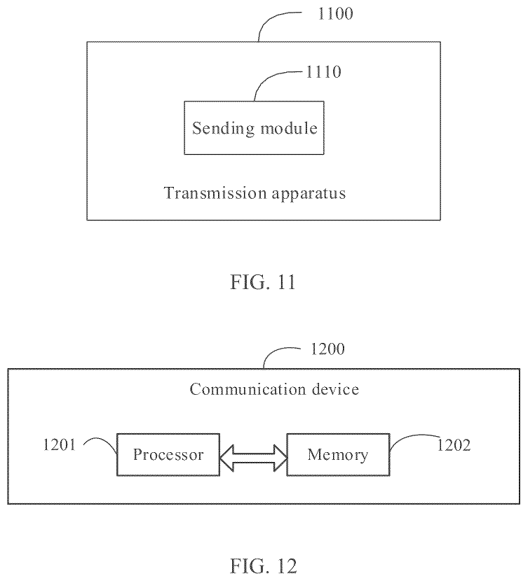

FIG. 11 is a second schematic diagram of a structure of a transmission apparatus according to an embodiment of this application. As shown in FIG. 11, the transmission apparatus 1100 includes:
a sending module 1110, configured to send first indication information to a terminal, where the first indication information includes at least one of the following:
number(s) of one or more CORESETs, or a quantity of one or more CORESETs, or number(s) of one or more CORESET pools;
one or more TCI states, or one or more TCI state sets;
one or more time windows;
a number of an enabled or disabled TRP, or a quantity of enabled or disabled TRPs; and
a mode of an enabled or disabled TRP.

In this embodiment of this application, the first indication information is sent to the terminal, where the first indication information is used to indicate an energy saving or working mode of a network-side device, to dynamically indicate a multi-TRP working state of the network-side device to the terminal; and the terminal performs a corresponding operation based on the first indication information. In this way, energy consumption of the terminal can be reduced.

In some embodiments, the CORESET is in a correspondence with one or more TRPs, or the CORESET pool is in a correspondence with one or more TRPs.

In some embodiments, the CORESET is in a correspondence with an enabled or disabled TRP, or the CORESET pool is in a correspondence with an enabled or disabled TRP.

In some embodiments, the TCI state is in a correspondence with an enabled or disabled TRP, or the TCI state set is in a correspondence with an enabled or disabled TRP.

In some embodiments, the TCI state is in a correspondence with one or more TRPs, or the TCI state set is in a correspondence with one or more TRPs.

In some embodiments, the time window corresponds to a time or a time unit within which a TRP is in an enabled state or a disabled state.

In some embodiments, an indication granularity of the first indication information includes: per cell or per cell group.

In some embodiments, the sending module 1110 is configured to perform at least one of the following:
sending radio resource control RRC signaling, where the RRC signaling carries the first indication information;
sending group common downlink control information DCI, where the group common DCI includes one or more indication fields for indicating the first indication information, and each indication field is applied to all terminals receiving the group common DCI, or each indication field is applied to one of a plurality of terminals receiving the group common DCI; and
sending a media access control control element MAC CE, where the MAC CE includes one or more indication fields for indicating the first indication information, and each indication field is applied to all terminals receiving the MAC CE, or each indication field is applied to one of a plurality of terminals receiving the MAC CE.

The transmission apparatus provided in this embodiment of this application can dynamically indicate the TRP working state of the network-side device, so that the terminal can perform one or more corresponding operations of PDCCH monitoring, PDSCH rate matching, HARQ-ACK feedback, and QCL determining based on the dynamic indication, thereby reducing energy consumption of the network-side device and the terminal.

In some embodiments, as shown in FIG. 12, an embodiment of this application further provides a communication device 1200, including a processor 1201 and a memory 1202. The memory 1202 stores a program or instruction capable of running on the processor 1201. For example, when the communication device 1200 is a terminal, and the program or instruction is executed by the processor 1201, the steps of the foregoing transmission method embodiment are implemented, with the same technical effect achieved. When the communication device 1200 is a network-side device, and the program or instruction is executed by the processor 1201, the steps of the foregoing transmission method embodiment are implemented, with the same technical effect achieved. To avoid repetition, details are not described herein again.

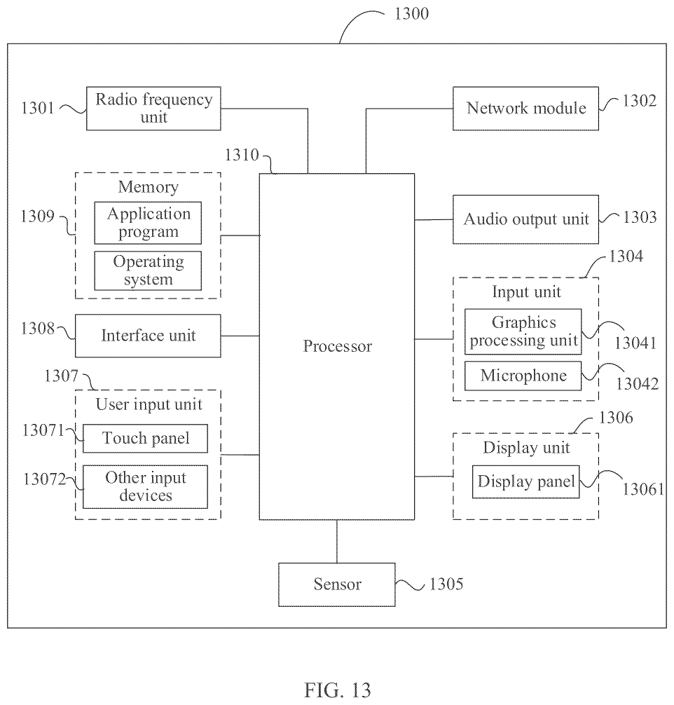

An embodiment of this application further provides a terminal, including a processor and a communication interface. The communication interface is configured to obtain first indication information, and the processor is configured to perform a first operation based on the first indication information, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP; and the first operation includes at least one of the following operations: monitoring or not monitoring a PDCCH; performing or not performing rate matching; feeding back or not feeding back HARQ-ACK information or a HARQ-ACK codebook; and determining QCL information of a PDSCH. The terminal embodiment corresponds to the foregoing terminal-side method embodiment, and each implementation process and implementation of the foregoing method embodiment can be applied to the terminal embodiment, with the same technical effect achieved. For example, FIG. 13 is a schematic diagram of a hardware structure of a terminal for implementing an embodiment of this application.

The terminal 1300 includes but is not limited to at least some components such as a radio frequency unit 1301, a network module 1302, an audio output unit 1303, an input unit 1304, a sensor 1305, a display unit 1306, a user input unit 1307, an interface unit 1308, a memory 1309, and a processor 1310.

A person skilled in the art may understand that the terminal 1300 may further include a power supply (for example, a battery) supplying power to all components. The power supply may be logically connected to the processor 1310 through a power management system. In this way, functions such as charge management, discharge management, and power consumption management are implemented by using the power management system. The terminal structure shown in FIG. 13 does not constitute a limitation on the terminal. The terminal may include more or fewer components than those shown in the figure, or some components are combined, or component arrangements are different. Details are not described herein again.

It should be understood that, in this embodiment of this application, the input unit 1304 may include a Graphics Processing Unit (GPU) 13041 and a microphone 13042. The graphics processing unit 13041 processes image data of a still picture or video obtained by an image capture apparatus (such as a camera) in a video capture mode or an image capture mode. The display unit 1306 may include a display panel 13061, and the display panel 13061 may be configured in a form of a liquid crystal display, an organic light-emitting diode, or the like. The user input unit 1307 includes at least one of a touch panel 13071 and other input devices 13072. The touch panel 13071 is also referred to as a touchscreen. The touch panel 13071 may include two parts: a touch detection apparatus and a touch controller. The other input devices 13072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1301 may transmit the downlink data to the processor 1310 for processing. In addition, the radio frequency unit 1301 may send uplink data to the network-side device. Usually, the radio frequency unit 1301 includes but is not limited to an antenna, an amplifier, a transceiver, a coupler, a low noise amplifier, a duplexer, and the like.

The memory 1309 may be configured to store software programs or instruction and various data. The memory 1309 may primarily include a first storage area for storing programs or instruction and a second storage area for storing data. The first storage area may store an operating system, an application program or instruction required by at least one function (such as an audio play function and an image play function), and the like. In addition, the memory 1309 may include a volatile memory or a non-volatile memory, or the memory 1309 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDR SDRAM), an Enhanced SDRAM (ESDRAM), a Synch Link DRAM (SLDRAM), and a Direct Rambus RAM (DRRAM). The memory 1309 in this embodiment of this application includes but is not limited to these and any other suitable types of memories.

The processor 1310 may include one or more processing units. In some embodiments, the processor 1310 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may be not integrated in the processor 1310.

The radio frequency unit 1301 is configured to obtain first indication information, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP.

The processor 1310 is configured to perform a first operation based on the first indication information, where the first operation includes at least one of the following operations: monitoring or not monitoring a PDCCH; performing or not performing rate matching; feeding back or not feeding back HARQ-ACK information or a HARQ-ACK codebook; and determining QCL information of a PDSCH.

In this embodiment of this application, the terminal obtains the first indication information, where the first indication information is used to indicate an energy saving or working mode of the network-side device, to dynamically indicate a multi-TRP working state of the network-side device; and the terminal performs a corresponding operation based on the first indication information. In this way, energy consumption of the terminal can be reduced.

In some embodiments, the CORESET is in a correspondence with one or more TRPs, or the CORESET pool is in a correspondence with one or more TRPs.

In some embodiments, the CORESET is in a correspondence with an enabled or disabled TRP, or the CORESET pool is in a correspondence with an enabled or disabled TRP.

In some embodiments, the TCI state is in a correspondence with one or more TRPs, or the TCI state set is in a correspondence with one or more TRPs.

In some embodiments, the TCI state is in a correspondence with an enabled or disabled TRP, or the TCI state set is in a correspondence with an enabled or disabled TRP.

In some embodiments, the time window corresponds to a time or a time unit within which a TRP is in an enabled state or a disabled state.

In some embodiments, an indication granularity of the first indication information includes: per cell or per cell group.

In some embodiments, the radio frequency unit 1301 is configured to perform at least one of the following:
receiving radio resource control RRC signaling, where the RRC signaling carries the first indication information;
receiving group common downlink control information DCI, where the group common DCI includes one or more indication fields for indicating the first indication information, and each indication field is applied to all terminals receiving the group common DCI, or each indication field is applied to one of a plurality of terminals receiving the group common DCI; and
receiving a media access control control element MAC CE, where the MAC CE includes one or more indication fields for indicating the first indication information, and each indication field is applied to all terminals receiving the MAC CE, or each indication field is applied to one of a plurality of terminals receiving the MAC CE.

In some embodiments, the processor 1310 is configured to perform at least one of the following:
monitoring the corresponding PDCCH based on the CORESET or the CORESET pool indicated by the first indication information; and
monitoring, based on all configured CORESETs or CORESET pools, a corresponding PDCCH in a remaining CORESET or CORESET pool other than the CORESET or the CORESET pool indicated by the first indication information.

In some embodiments, the processor 1310 is configured to perform at least one of the following:
monitoring a corresponding PDCCH in a first CORESET or CORESET pool based on the TCI state or the TCI state set indicated by the first indication information, where a TCI state of the first CORESET or CORESET pool is at least one of the indicated TCI state or TCI states in the indicated TCI state set; and
monitoring a corresponding PDCCH in a second CORESET or CORESET pool based on all configured or activated TCI states and the TCI state or the TCI state set indicated by the first indication information, where a TCI state of the second CORESET or CORESET pool is any one of remaining TCI states other than the indicated TCI state or those in the TCI state set among all the configured or activated TCI states.

In some embodiments, the processor 1310 is configured to perform at least one of the following:
monitoring, based on an enabled TRP indicated by the first indication information, a corresponding PDCCH in a CORESET corresponding to the enabled TRP; and
not monitoring, based on a disabled TRP indicated by the first indication information, a corresponding PDCCH in a CORESET corresponding to the disabled TRP.

In some embodiments, the processor 1310 is configured to perform at least one of the following:
monitoring, based on the time window indicated by the first indication information, a corresponding PDCCH within a time or time unit when a TRP is in an enabled state, or not monitoring a corresponding PDCCH within a time or time unit when a TRP is in a disabled state; and
monitoring, based on the mode of the enabled or disabled TRP indicated by the first indication information, the corresponding PDCCH within the time or time unit when the TRP is in the enabled state, or not monitoring the corresponding PDCCH within the time or time unit when the TRP is in the disabled state.

In some embodiments, the processor 1310 is configured to perform at least one of the following:
performing or not performing rate matching on the PDSCH on a first resource based on the CORESET or CORESET pool, or the TCI state or TCI state set, or the enabled or disabled TRP that is indicated by the first indication information.

In some embodiments, the first resource is a resource determined by the terminal based on a rate matching pattern configured by a network; or
the first resource is a resource corresponding to a rate matching pattern associated with the indicated CORESET or CORESET pool, or TCI state or TCI state set, or enabled or disabled TRP.

In some embodiments, the processor 1310 is configured to perform at least one of the following:
feeding back or not feeding back first HARQ-ACK information or a first HARQ-ACK codebook based on the CORESET or CORESET pool, or the TCI state or TCI state set, or the enabled or disabled TRP that is indicated by the first indication information, where
the first HARQ-ACK information or first HARQ-ACK codebook is associated with the indicated CORESET or CORESET pool, or TCI state or TCI state set, or enabled or disabled TRP.

In some embodiments, that the first HARQ-ACK information or first HARQ-ACK codebook is associated with the indicated CORESET or CORESET pool, or TCI state or TCI state set, or enabled or disabled TRP includes at least one of the following:
the first HARQ-ACK information or first HARQ-ACK codebook is associated with the indicated CORESET or CORESET pool, where the CORESET or CORESET pool is used to receive the PDCCH for scheduling the feedback of the first HARQ-ACK information or first HARQ-ACK codebook;
the first HARQ-ACK information or first HARQ-ACK codebook is associated with a third CORESET or CORESET pool, where a TCI state of the third CORESET or CORESET pool is the indicated TCI state, and the third CORESET or CORESET pool is used to receive the PDCCH for scheduling the feedback of the first HARQ-ACK information or first HARQ-ACK codebook; and
the first HARQ-ACK information or first HARQ-ACK codebook is associated with a fourth CORESET or CORESET pool, where the fourth CORESET or CORESET pool corresponds to a first TRP, and the fourth CORESET or CORESET pool is used to receive the PDCCH for scheduling the feedback of the first HARQ-ACK information or first HARQ-ACK codebook.

In some embodiments, the not feeding back first HARQ-ACK information or a first HARQ-ACK codebook includes at least one of the following:
determining the disabled TRP based on the CORESET or CORESET pool, or the TCI state or TCI state set that is indicated by the first indication information, and not generating HARQ-ACK information or a HARQ-ACK codebook of the PDSCH corresponding to the disabled TRP; and
not generating, based on the disabled TRP indicated by the first indication information, the HARQ-ACK information or HARQ-ACK codebook of the PDSCH corresponding to the disabled TRP.

In some embodiments, the HARQ-ACK codebook includes a semi-static codebook or a dynamic codebook.

In some embodiments, the processor 1310 is configured to:
determine a target CORESET or CORESET pool based on the CORESET or the CORESET pool indicated by the first indication information; and
determine QCL information of a demodulation reference signal DMRS port of the PDSCH based on a QCL parameter of the target CORESET or CORESET pool, where
the target CORESET or CORESET pool is a CORESET or CORESET pool with a largest or smallest number among the numbers of the indicated CORESETs or CORESET pools; or
the target CORESET or CORESET pool is a CORESET or CORESET pool with a largest or smallest number among remaining CORESETs or CORESET pools other than the indicated CORESETs or CORESET pools based on all configured CORESETs or CORESET pools.

In some embodiments, the processor 1310 is configured to:
determine a target TCI state or TCI state set based on the TCI state or the TCI state set indicated by the first indication information; and
determine QCL information of a DMRS port of the PDSCH based on a QCL parameter of a CORESET or CORESET pool corresponding to the target TCI state or TCI state set, where
the target TCI state or TCI state set is a TCI state or TCI state set with a largest or smallest number among the indicated TCI states or TCI state sets; or
the target TCI state or TCI state set is a TCI state or TCI state set with a largest or smallest number among remaining TCI states or TCI state sets other than the indicated TCI states or TCI state sets based on all configured or activated TCI states or TCI state sets.

In some embodiments, the processor 1310 is configured to:
determine, based on the enabled TRP indicated by the first indication information, a CORESET with a largest or smallest number and corresponding to the enabled TRP; and
determine QCL information of a DMRS port of the PDSCH based on a QCL parameter of the CORESET with the largest or smallest number and corresponding to the enabled TRP.

In some embodiments, the radio frequency unit 1301 is further configured to receive second indication information before the first indication information takes effect, where the second indication information is used to indicate a plurality of TCI states, and the plurality of TCI states correspond to all configured TRPs; and
the processor 1310 is further configured to determine, based on a first or last TCI state among the plurality of TCI states indicated by the second indication information, a TCI state corresponding to downlink transmission, where
the first or last TCI state among the plurality of TCI states is a TCI state corresponding to the enabled TRP.

In some embodiments, the terminal does not expect to receive second indication information, the second indication information is used to indicate a plurality of TCI states, and the plurality of TCI states include a TCI state corresponding to the disabled TRP.

The terminal provided in this embodiment of this application can dynamically obtain the TRP working state indicated by the network-side device, and perform one or more corresponding operations of PDCCH monitoring, PDSCH rate matching, HARQ-ACK feedback, and QCL determining based on the dynamic indication, thereby effectively reducing energy consumption of the terminal.

An embodiment of this application further provides a network-side device, including a processor and a communication interface. The communication interface is configured to send first indication information to a terminal, where the first indication information includes at least one of the following: number(s) of one or more CORESETs, or a quantity of one or more CORESETs, or number(s) of one or more CORESET pools; one or more TCI states, or one or more TCI state sets; one or more time windows; a number of an enabled or disabled TRP, or a quantity of enabled or disabled TRPs; and a mode of an enabled or disabled TRP. The network-side device embodiment corresponds to the foregoing method embodiment of the network-side device, and each implementation process and implementation of the foregoing method embodiment can be applied to the network-side device embodiment, with the same technical effect achieved.

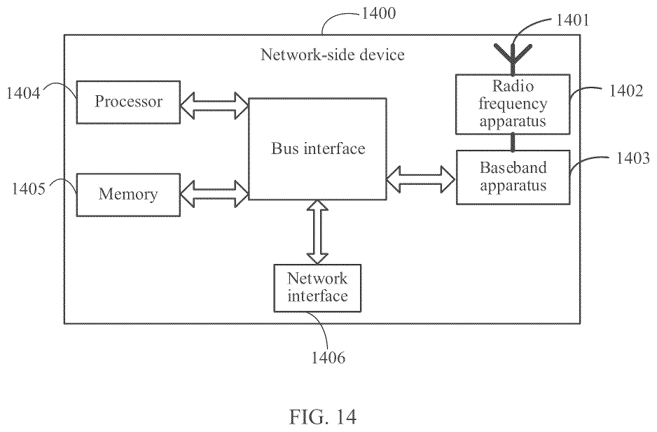

For example, an embodiment of this application further provides a network-side device. As shown in FIG. 14, the network-side device 1400 includes an antenna 1401, a radio frequency apparatus 1402, a baseband apparatus 1403, a processor 1404, and a memory 1405. The antenna 1401 is connected to the radio frequency apparatus 1402. In an uplink direction, the radio frequency apparatus 1402 receives information by using the antenna 1401, and sends the received information to the baseband apparatus 1403 for processing. In a downlink direction, the baseband apparatus 1403 processes to-be-sent information, and sends the information to the radio frequency apparatus 1402; and the radio frequency apparatus 1402 processes the received information and then sends the information out by using the antenna 1401.

The method performed by the network-side device in the foregoing embodiment may be implemented in the baseband apparatus 1403. The baseband apparatus 1403 includes a baseband processor.

The baseband apparatus 1403 may include, for example, at least one baseband unit, where a plurality of chips are disposed on the baseband unit. As shown in FIG. 14, one of the chips is, for example, the baseband processor, connected to the memory 1405 by using a bus interface, to invoke a program in the memory 1405 to perform the operation of the network-side device shown in the foregoing method embodiment.

The network-side device may further include a network interface 1406, where the interface is, for example, a Common Public Radio Interface (CPRI).

For example, the network-side device 1400 in this embodiment of the present disclosure further includes a program or instruction stored in the memory 1405 and capable of running on the processor 1404. When the processor 1404 invokes the program or instruction in the memory 1405, the method performed by each module shown in FIG. 8 is performed, with the same technical effect achieved. To avoid repetition, details are not described herein again.

An embodiment of this application further provides a readable storage medium. The readable storage medium stores a program or instruction. When the program or instruction is executed by a processor, each process of the foregoing transmission method embodiment is implemented, with the same technical effect achieved. To avoid repetition, details are not described herein again.

The processor is a processor in the terminal in the foregoing embodiment. The readable storage medium includes a computer-readable storage medium, such as a computer read-only memory ROM, a random access memory RAM, a magnetic disk, or an optical disc.

In addition, an embodiment of this application provides a chip. The chip includes a processor and a communication interface. The communication interface is coupled to the processor. The processor is configured to run a program or instruction to implement each process of the foregoing transmission method embodiment, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing transmission method embodiment, with the same technical effect achieved. To avoid repetition, details are not described herein again.

An embodiment of this application further provides a transmission system, including a terminal and a network-side device. The terminal may be configured to perform the steps of the foregoing transmission method. The network-side device may be configured to perform the steps of the foregoing transmission method.

It should be noted that in this specification, the term “comprise”, “include”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

According to the foregoing description of the implementations, a person skilled in the art may clearly understand that the methods in the foregoing embodiments may be implemented by using software in combination with a necessary general hardware platform, or may be implemented by using hardware. In some embodiments, the technical solutions of this application entirely or the part contributing to the prior art may be implemented in a form of a computer software product. The computer software product is stored in a storage medium (such as a ROM/RAM, a magnetic disk, or an optical disc), and includes several instruction for instructing a terminal (which may be a mobile phone, a computer, a server, an air conditioner, a network device, or the like) to perform the methods described in the embodiments of this application.

The foregoing describes the embodiments of this application with reference to the accompanying drawings. However, this application is not limited to the foregoing embodiments. The foregoing embodiments are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. A transmission method, comprising:
obtaining, by a terminal, first indication information; and
performing, by the terminal, a first operation based on the first indication information, wherein:
the first indication information comprises at least one of the following:
number of one or more Control Resource Sets (CORESETs), or the quantity of one or more CORESETs, or number of one or more CORESET pools,
one or more Transmission Configuration Indicator (TCI) states, or one or more TCI state sets,
one or more time windows,
number of an enabled or disabled Transmission and Reception Point (TRP), or the quantity of enabled or disabled TRPs, or
a mode of an enabled or disabled TRP; and
the first operation comprises at least one of the following operations:
monitoring or not monitoring a Physical Downlink Control Channel (PDCCH),
performing or not performing rate matching,
feeding back or not feeding back Hybrid Automatic Repeat reQuest ACKnowledgment (HARQ-ACK) information or a HARQ-ACK codebook, or
determining Quasi-Co-Location (QCL) information of a Physical Downlink Shared Channel (PDSCH).

2. The transmission method according to claim 1,
wherein:
the CORESET is in a correspondence with one or more TRPs, or the CORESET pool is in a correspondence with one or more TRPs; or
the CORESET is in a correspondence with an enabled or disabled TRP, or the CORESET pool is in a correspondence with an enabled or disabled TRP; or
the TCI state is in a correspondence with one or more TRPs, or the TCI state set is in a correspondence with one or more TRPs; or
the TCI state is in a correspondence with an enabled or disabled TRP, or the TCI state set is in a correspondence with an enabled or disabled TRP; or
the time window corresponds to a time or a time unit within which a TRP is in an enabled state or a disabled state.

3. The transmission method according to claim 1, wherein obtaining, by the terminal, the first indication information comprises at least one of the following:
receiving, by the terminal, Radio Resource Control (RRC) signaling, wherein the RRC signaling carries the first indication information,
receiving, by the terminal, group common Downlink Control Information (DCI), wherein the group common DCI comprises one or more indication fields for indicating the first indication information, and each indication field is applied to all terminals receiving the group common DCI, or each indication field is applied to one of a plurality of terminals receiving the group common DCI, or
receiving, by the terminal, a Media Access Control Control Element (MAC CE), wherein the MAC CE comprises one or more indication fields for indicating the first indication information, and each indication field is applied to all terminals receiving the MAC CE, or each indication field is applied to one of a plurality of terminals receiving the MAC CE.

4. The transmission method according to claim 1, wherein performing, by the terminal, the first operation based on the first indication information comprises at least one of the following:
monitoring, by the terminal, a corresponding PDCCH based on the CORESET or the CORESET pool indicated by the first indication information, or
monitoring, by the terminal based on all configured CORESETs or CORESET pools, a corresponding PDCCH in a remaining CORESET or CORESET pool other than the CORESET or the CORESET pool indicated by the first indication information.

5. The transmission method according to claim 1, wherein performing, by the terminal, the first operation based on the first indication information comprises at least one of the following:
monitoring, by the terminal, a corresponding PDCCH in a first CORESET or CORESET pool based on the TCI state or the TCI state set indicated by the first indication information, wherein a TCI state of the first CORESET or CORESET pool is at least one of the indicated TCI state or TCI states in the indicated TCI state set,
monitoring, by the terminal, a corresponding PDCCH in a second CORESET or CORESET pool based on all configured or activated TCI states and the TCI state or the TCI state set indicated by the first indication information, wherein a TCI state of the second CORESET or CORESET pool is any one of remaining TCI states other than the indicated TCI state or those in the TCI state set among all the configured or activated TCI states,
monitoring, by the terminal based on an enabled TRP indicated by the first indication information, a corresponding PDCCH in a CORESET corresponding to the enabled TRP,
not monitoring, by the terminal based on a disabled TRP indicated by the first indication information, a corresponding PDCCH in a CORESET corresponding to the disabled TRP, monitoring, by the terminal based on the time window indicated by the first indication information, a corresponding PDCCH within a time or time unit when a TRP is in an enabled state, or not monitoring a corresponding PDCCH within a time or time unit when a TRP is in a disabled state,
monitoring, by the terminal based on the mode of the enabled or disabled TRP indicated by the first indication information, the corresponding PDCCH within the time or time unit when the TRP is in the enabled state, or not monitoring the corresponding PDCCH within the time or time unit when the TRP is in the disabled state, or
performing or not performing, by the terminal, rate matching on the PDSCH on a first resource based on the CORESET or CORESET pool, or the TCI state or TCI state set, or the enabled or disabled TRP that is indicated by the first indication information.

6. The transmission method according to claim 5, wherein the first resource is a resource determined by the terminal based on a rate matching pattern configured by a network, or
the first resource is a resource corresponding to a rate matching pattern associated with the indicated CORESET or CORESET pool, or TCI state or TCI state set, or enabled or disabled TRP.

7. The transmission method according to claim 1, wherein performing, by the terminal, the first operation based on the first indication information comprises at least one of the following:
feeding back or not feeding back, by the terminal, first HARQ-ACK information or a first HARQ-ACK codebook based on the CORESET or CORESET pool, or the TCI state or TCI state set, or the enabled or disabled TRP that is indicated by the first indication information, wherein
the first HARQ-ACK information or first HARQ-ACK codebook is associated with the indicated CORESET or CORESET pool, or TCI state or TCI state set, or enabled or disabled TRP.

8. The transmission method according to claim 7, wherein that the first HARQ-ACK information or first HARQ-ACK codebook is associated with the indicated CORESET or CORESET pool, or TCI state or TCI state set, or enabled or disabled TRP comprises at least one of the following:
the first HARQ-ACK information or first HARQ-ACK codebook is associated with the indicated CORESET or CORESET pool, wherein the CORESET or CORESET pool is used to receive the PDCCH for scheduling the feedback of the first HARQ-ACK information or first HARQ-ACK codebook,
the first HARQ-ACK information or first HARQ-ACK codebook is associated with a third CORESET or CORESET pool, wherein a TCI state of the third CORESET or CORESET pool is the indicated TCI state, and the third CORESET or CORESET pool is used to receive the PDCCH for scheduling the feedback of the first HARQ-ACK information or first HARQ-ACK codebook, or
the first HARQ-ACK information or first HARQ-ACK codebook is associated with a fourth CORESET or CORESET pool, wherein the fourth CORESET or CORESET pool corresponds to a first TRP, and the fourth CORESET or CORESET pool is used to receive the PDCCH for scheduling the feedback of the first HARQ-ACK information or first HARQ-ACK codebook.

9. The transmission method according to claim 7, wherein the not feeding back first HARQ-ACK information or a first HARQ-ACK codebook comprises at least one of the following:
determining, by the terminal, the disabled TRP based on the CORESET or CORESET pool, or the TCI state or TCI state set that is indicated by the first indication information, and not generating HARQ-ACK information or a HARQ-ACK codebook of the PDSCH corresponding to the disabled TRP, or
not generating, by the terminal based on the disabled TRP indicated by the first indication information, the HARQ-ACK information or HARQ-ACK codebook of the PDSCH corresponding to the disabled TRP.

10. The transmission method according to claim 1, wherein performing, by the terminal, the first operation based on the first indication information comprises:
determining, by the terminal, a target CORESET or CORESET pool based on the CORESET or the CORESET pool indicated by the first indication information, or
determining QCL information of a Demodulation Reference Signal (DMRS) port of the PDSCH based on a QCL parameter of the target CORESET or CORESET pool,
wherein:
the target CORESET or CORESET pool is a CORESET or CORESET pool with the largest or smallest number among the numbers of the indicated CORESETs or CORESET pools; or
the target CORESET or CORESET pool is a CORESET or CORESET pool with the largest or smallest number among remaining CORESETs or CORESET pools other than the indicated CORESETs or CORESET pools based on all configured CORESETs or CORESET pools.

11. The transmission method according to claim 1, wherein performing, by the terminal, the first operation based on the first indication information comprises:
determining, by the terminal, a target TCI state or TCI state set based on the TCI state or the TCI state set indicated by the first indication information; and
determining QCL information of a Demodulation Reference Signal (DMRS) port of the PDSCH based on a QCL parameter of a CORESET or CORESET pool corresponding to the target TCI state or TCI state set, wherein:
the target TCI state or TCI state set is a TCI state or TCI state set with the largest or smallest number among the indicated TCI states or TCI state sets; or
the target TCI state or TCI state set is a TCI state or TCI state set with the largest or smallest number among remaining TCI states or TCI state sets other than the indicated TCI states or TCI state sets based on all configured or activated TCI states or TCI state sets.

12. The transmission method according to claim 1, wherein performing, by the terminal, the first operation based on the first indication information comprises:
determining, by the terminal based on the enabled TRP indicated by the first indication information, a CORESET with the largest or smallest number and corresponding to the enabled TRP; and
determining QCL information of a Demodulation Reference Signal (DMRS) port of the PDSCH based on a QCL parameter of the CORESET with the largest or smallest number and corresponding to the enabled TRP.

13. The transmission method according to claim 1, further comprising:
before the first indication information takes effect, receiving, by the terminal, second indication information, wherein the second indication information is used to indicate a plurality of TCI states, and the plurality of TCI states correspond to all configured TRPs; and
determining, by the terminal based on the first or last TCI state among the plurality of TCI states indicated by the second indication information, a TCI state corresponding to downlink transmission, wherein
the first or last TCI state among the plurality of TCI states is a TCI state corresponding to the enabled TRP.

14. The transmission method according to claim 1,
wherein:
the terminal does not expect to receive second indication information,
the second indication information is used to indicate a plurality of TCI states, and
the plurality of TCI states comprise a TCI state corresponding to the disabled TRP.

15. A transmission method, comprising:
sending, by a network-side device, first indication information to a terminal, wherein the first indication information comprises at least one of the following:
number of one or more Control Resource Sets (CORESETs), or the quantity of one or more CORESETs, or number of one or more CORESET pools,
one or more Transmission Configuration Indicator (TCI) states, or one or more TCI state sets,
one or more time windows,
number of an enabled or disabled Transmission and Reception Point (TRP), or the quantity of enabled or disabled TRPs, or
a mode of an enabled or disabled TRP.

16. The transmission method according to claim 15,
wherein:
the CORESET is in a correspondence with one or more TRPs, or the CORESET pool is in a correspondence with one or more TRPs, or
the CORESET is in a correspondence with an enabled or disabled TRP, or the CORESET pool is in a correspondence with an enabled or disabled TRP, or
the TCI state is in a correspondence with an enabled or disabled TRP, or the TCI state set is in a correspondence with an enabled or disabled TRP, or
the TCI state is in a correspondence with one or more TRPs, or the TCI state set is in a correspondence with one or more TRPs, or
the time window corresponds to a time or a time unit within which a TRP is in an enabled state or a disabled state.

17. The transmission method according to claim 15, wherein an indication granularity of the first indication information comprises: per cell or per cell group.

18. The transmission method according to claim 15, wherein sending, by the network-side device, the first indication information comprises at least one of the following:
sending, by the network-side device, Radio Resource Control (RRC) signaling, wherein the RRC signaling carries the first indication information,
sending, by the network-side device, group common Downlink Control Information (DCI), wherein the group common DCI comprises one or more indication fields for indicating the first indication information, and each indication field is applied to all terminals receiving the group common DCI, or each indication field is applied to one of a plurality of terminals receiving the group common DCI; or
sending, by the network-side device, a Media Access Control Control Element (MAC CE),
wherein:
the MAC CE comprises one or more indication fields for indicating the first indication information, and
each indication field is applied to all terminals receiving the MAC CE, or each indication field is applied to one of a plurality of terminals receiving the MAC CE.

19. A terminal, comprising: a processor; and a memory having a computer program or an instruction stored thereon the processor, wherein the computer program or the instruction, when executed by the processor, causes the processor to perform operations, comprising:
obtaining first indication information; and
performing a first operation based on the first indication information, wherein:
the first indication information comprises at least one of the following:
number of one or more Control Resource Sets (CORESETs), or the quantity of one or more CORESETs, or number of one or more CORESET pools,
one or more Transmission Configuration Indicator (TCI) states, or one or more TCI state sets,
one or more time windows,
number of an enabled or disabled Transmission and Reception Point (TRP), or the quantity of enabled or disabled TRPs, or
a mode of an enabled or disabled TRP; and
the first operation comprises at least one of the following operations:
monitoring or not monitoring a Physical Downlink Control Channel (PDCCH),
performing or not performing rate matching,
feeding back or not feeding back Hybrid Automatic Repeat reQuest ACKnowledgment (HARQ-ACK) information or a HARQ-ACK codebook, or
determining Quasi-Co-Location (QCL) information of a Physical Downlink Shared Channel (PDSCH).

20. A network-side device, comprising: a processor, and a memory having a computer program or an instruction stored thereon, wherein the computer program or the instruction, when executed by the processor, causes the processor to perform the transmission method according to claim 15.
